(19) United States
(12) Patent Application Publication
(10) Pub. No.: US 2012/0056912 A1
(43) Pub. Date: Mar. 8, 2012

(54) BACKLIGHT APPARATUS, DISPLAY APPARATUS AND LIGHTING APPARATUS

(75) Inventor: Takeshi ADACHI, Saitama (JP)

(73) Assignees: ATRC CORPORATION, Saitama (JP); MITSUMI ELECTRIC CO., LTD., Tokyo (JP)

(21) Appl. No.: 13/221,965

(22) Filed: Aug. 31, 2011

(30) Foreign Application Priority Data
Sep. 3, 2010 (JP) 2010-197615

(51) Int. Cl. G09G 5/10; H05B 37/00

(52) U.S. Cl. 345/690; 315/122

(57) ABSTRACT

A backlight apparatus for illuminating a display unit, including: a light-emitting element block including a plurality of light-emitting elements that are connected serially; and a driving control unit configured to control driving for each of the plurality of light-emitting elements by supplying a current to the light-emitting element block, wherein each of the plurality of light-emitting elements is provided with a bypass circuit such that, even when a break occurs in a light-emitting element, a current from the driving control unit is supplied to the other light-emitting elements.

### CROSS-REFERENCE TO RELATED APPLICATION

The present application is based upon and claims the benefit of priority of Japanese Patent Application No. 2010-197615, filed on Sep. 3, 2010, the entire contents of which are incorporated herein by reference.

### BACKGROUND OF THE INVENTION

1. Field of the Invention

The present invention relates to a backlight apparatus, a display apparatus including the backlight apparatus and a lighting apparatus including the backlight apparatus. More particularly, the present invention relates to a backlight apparatus, a display apparatus including the backlight apparatus and a lighting apparatus including the backlight apparatus for providing appropriate backlight by applying drive control against unevenness of backlight brightness and a break.

2. Description of the Related Art

LED (Light Emitting Diode) backlights are attracting attention as backlights for illuminating an optical modulation device, from the backside, such as a liquid crystal panel that is commonly used for a display apparatus for displaying an image and a video and the like.

There are several types of LED backlights. For example, in one type of LED backlights, white LEDs are arranged in order to emit white illuminating light. In another type of LED backlights, LEDs of three colors of R (red), G (green) and B (blue) are arranged so that the three colors are mixed to emit white light. Also, as to the white LED, there are several types. In one type of the white LED, fluorescent material is combined with a short-wavelength LED to obtain white light. In another type, fluorescent material is combined with a blue LED to obtain white light. Also, there is a type in which yellow fluorescent material is combined with a blue LED to obtain white light.

In addition, as conventional techniques, it is known that a plurality of LEDs are connected serially in accordance with a display size and the like for using the LEDs as illumination or backlight of a display apparatus (refer to Japanese Laid-Open Patent Applications No. 2007-109691 and No. 2006-127798, for example).

Also, in conventional techniques, a driver IC (Integrated Circuit) is used for driving a plurality of LEDs that are connected serially. For example, in a case when using low-voltage driver ICs, each of the low-voltage driver ICs controls a limited number of LEDs.

Also, in conventional technique, the number of LEDs to be driven is set according to a value of withstand voltage of the driver IC. For example, since the withstand voltage of one LED is about 3 V, a driver IC of withstand voltage of about 30 V is necessary for 10 LEDs, and a driver IC of withstand voltage of about 60 V is necessary for 20 LEDs.

In addition, in the case where a plurality of LEDs are arranged serially for illumination as mentioned above, if an open fault occurs in at least one of the serially-connected LEDs, no current is supplied to all of the LEDs so that every LED cannot be turned on. In the case when a short fault occurs in an LED, since a current flows through the other LEDs, the other LEDs can continue illumination. In recent years, as to the backlights using a plurality of LEDs, techniques against unevenness of brightness and a break and the like are known (refer to Japanese Laid-Open Patent Applications No. 2007-67313 and No. 2008-198430, for example).

In the technique described in Japanese Laid-Open Patent Applications No. 2007-67313, when an electric abnormality is detected in an LED unit, current control units of other LED units adjacent to the LED unit in which the electric abnormality is detected are controlled in order to increase illumination brightness of the other LED units. In the technique shown in Japanese Laid-Open Patent Applications No. 2008-198430, an LED drive control unit drives two adjacent LEDs while shifting phases of on/off of PWM modulation light.

However, according to the above-mentioned conventional techniques, since a plurality of driver ICs are used, unevenness occurs in currents flowing through LEDs due to variation of the driver ICs. Therefore, unevenness of brightness occurs. Also, factors of variations increase in consequence of secular change and temperature drifts and the like, which further increase unevenness of brightness.

### SUMMARY OF THE INVENTION

Accordingly, an object of the present invention is to provide a backlight apparatus, a display apparatus and a lighting apparatus for providing appropriate backlight by applying drive control against unevenness of backlight brightness and a break.

According to an embodiment of the present invention, there is provided a backlight apparatus for illuminating a display unit, including:

a light-emitting element block including a plurality of light-emitting elements that are connected serially; and

a driving control unit configured to control driving for each of the plurality of light-emitting elements by supplying a current to the light-emitting element block,

wherein each of the plurality of light-emitting elements is provided with a bypass circuit such that, even when a break occurs in a light-emitting element, a current from the driving control unit is supplied to other light-emitting elements.

According to another embodiment of the present invention, there is provided a display apparatus including:

a backlight apparatus;

a display unit to be illuminated by the backlight apparatus; and

a correction unit configured to correct brightness of the backlight apparatus according to an image displayed on the display unit,

the backlight apparatus including:

a light-emitting element block including a plurality of light-emitting elements that are connected serially; and

a driving control unit configured to control driving for each of the plurality of light-emitting elements by supplying a current to the light-emitting element block,

wherein each of the plurality of light-emitting elements is provided with a bypass circuit such that, even when a break occurs in a light-emitting element, a current from the driving control unit is supplied to other light-emitting elements.

According to still another embodiment of the present invention, there is provided a lighting apparatus, including:

a light-emitting element block including a plurality of light-emitting elements that are connected serially; and

a driving control unit configured to control driving for each of the plurality of light-emitting elements by supplying a current to the light-emitting element block;

wherein each of the plurality of light-emitting elements is provided with a bypass circuit such that, even when a break occurs in a light-emitting element, a current from the driving control unit is supplied to the other light-emitting elements.

Other objects and further features of the present invention will be apparent from the following detailed description when read in conjunction with the accompanying drawings.

### BRIEF DESCRIPTION OF THE DRAWINGS

FIGS. 1A-1C are diagrams showing examples of schematic configurations of brightness apparatuses;

FIGS. 2A and 2B are diagrams showing examples of block configurations in the present embodiment;

FIGS. 3A-3E are diagrams for placement examples of LED backlights;

FIGS. 4A-4C are diagrams showing an example of defect LED bypass driving control;

FIGS. 5A and 5B are diagrams showing examples of bypass circuits in the present embodiment;

FIGS. 6A and 6B are diagrams showing other examples of bypass circuits in the present embodiment;

FIG. 7 is a diagram showing an example of a functional configuration of a display apparatus including the backlight apparatus of the present embodiment; and

FIGS. 8A and 8B are diagrams for explaining other application examples of the backlight apparatus in the present embodiment.

### DESCRIPTION OF THE PREFERRED EMBODIMENTS

Preferred embodiments of the present invention are described below with reference to the accompanying drawings.

<Outline of Embodiment>

According to an embodiment of the present invention, a backlight apparatus (10) for illuminating a display unit (11) is provided. The backlight apparatus includes:

a light-emitting element block (12) including a plurality of light-emitting elements that are connected serially; and

a driving control unit (13) configured to control driving for each of the plurality of light-emitting elements by supplying a current to the light-emitting element block,

wherein each of the plurality of light-emitting elements is provided with a bypass circuit (32-36) such that, even when a break occurs in a light-emitting element, a current from the driving control unit (13) is supplied to other light-emitting elements.

According to the backlight apparatus, proper backlight can be provided by drive control against unevenness of brightness of backlight and a break.

In the backlight apparatus, at least one of an FET type switching circuit, a transistor type switching circuit and a zener diode circuit is used as the bypass circuit (32-36).

In the backlight apparatus, the driving control circuit (13) supplies the current to all of the light-emitting elements included in the light-emitting element block (12) by a voltage that is determined according to the number of the serially-connected light-emitting elements.

In the backlight apparatus, the light-emitting element is an LED (31).

According to another embodiment of the present invention, a display apparatus is provided. The display apparatus includes: the backlight apparatus (10); a display unit (49) to be illuminated by the backlight apparatus; and a correction unit configured to correct brightness of the backlight apparatus (10) according to an image displayed on the display unit.

The display apparatus may further include:

a block information obtaining unit (43) configured to divide each frame, included in an image signal input for displaying an image on the display unit, into blocks and to obtain image information for each of the blocks; and

a block-unit control unit (44) configured to perform control for correcting brightness of backlights for each of the blocks divided by the block information obtaining unit,

wherein the backlight apparatus (10) performs drive control of the backlights for each of the blocks based on brightness control information obtained by the block-unit control unit for the display unit (49).

The display apparatus may further include:

a backlight brightness correction unit (47) configured to perform correction on the input image signal based on the brightness control information for the backlights, wherein the display apparatus displays an image signal obtained by the backlight brightness correction unit (47) on the display unit (49).

According to still another embodiment of the present invention, a lighting apparatus (50) is provided. The lighting apparatus (50) includes:

a light-emitting element block including a plurality of light-emitting elements that are connected serially; and

a driving control unit (52) configured to control driving for each of the plurality of light-emitting elements by supplying a current to the light-emitting element block;

wherein each of the plurality of light-emitting elements is provided with a bypass circuit (32-36) such that, even when a break occurs in a light-emitting element, a current from the driving control unit is supplied to the other light-emitting elements.

The above reference symbols are merely examples, and the present invention is not limited by the reference symbols.

According to an embodiment of the present invention, a bypass circuit using automatic switching and the like is included in each LED in order to prevent other LEDs from being turned off due to a break of one of a plurality of LEDs arranged as backlights. When a break (disconnection) occurs, the break state is recovered by automatically causing a short. That is, in an embodiment of the present invention, an LED device including a switching circuit, and an external switching circuit are provided. Also, in an embodiment of the present invention, an LED driver IC performs current control in the automatic switching operation. More specifically, the driver IC controls LED currents to be constant when performing on/off of the switch.

In the following embodiments, a liquid crystal display is used as an example of the display apparatus, and LED is used as an example of a light-emitting element for emitting light as backlight. But, the present invention is not limited to these. Also, the backlight apparatus of the present invention can be applied to various apparatuses such as a lighting apparatus, a digital signage and a display and the like in which LEDs are serially connected, for example. In the present embodiments, the meaning of “image signal” includes both of a signal of a moving picture (moving image) and a signal of a still image.

<Schematic Configuration Example of Backlight Apparatus>

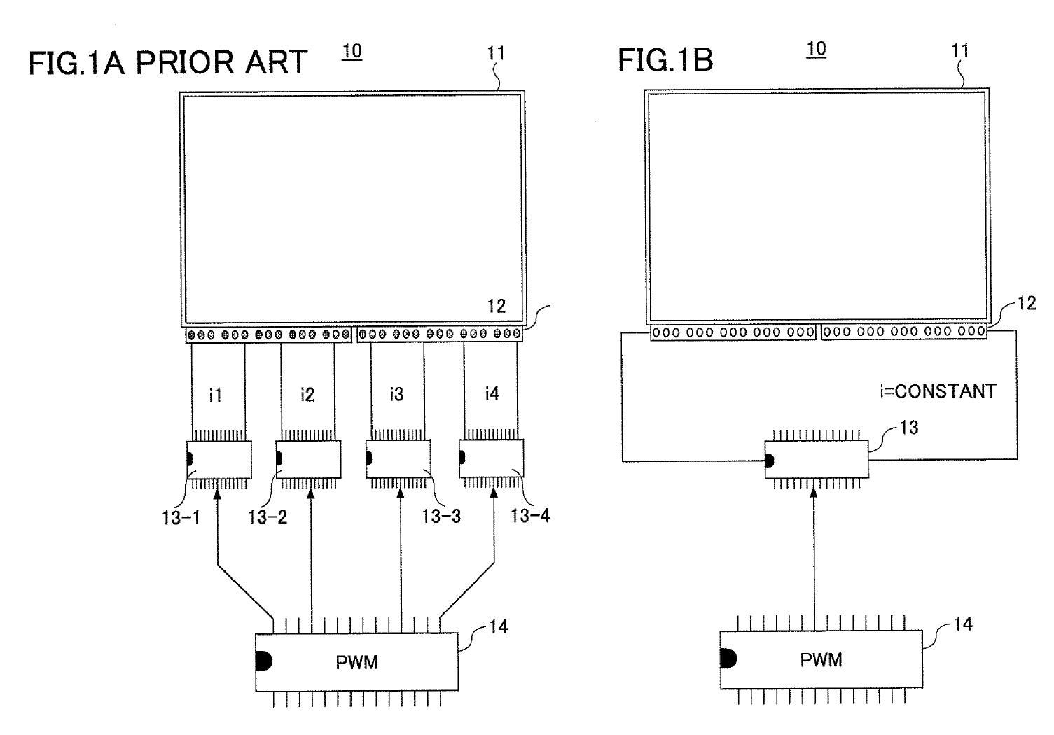

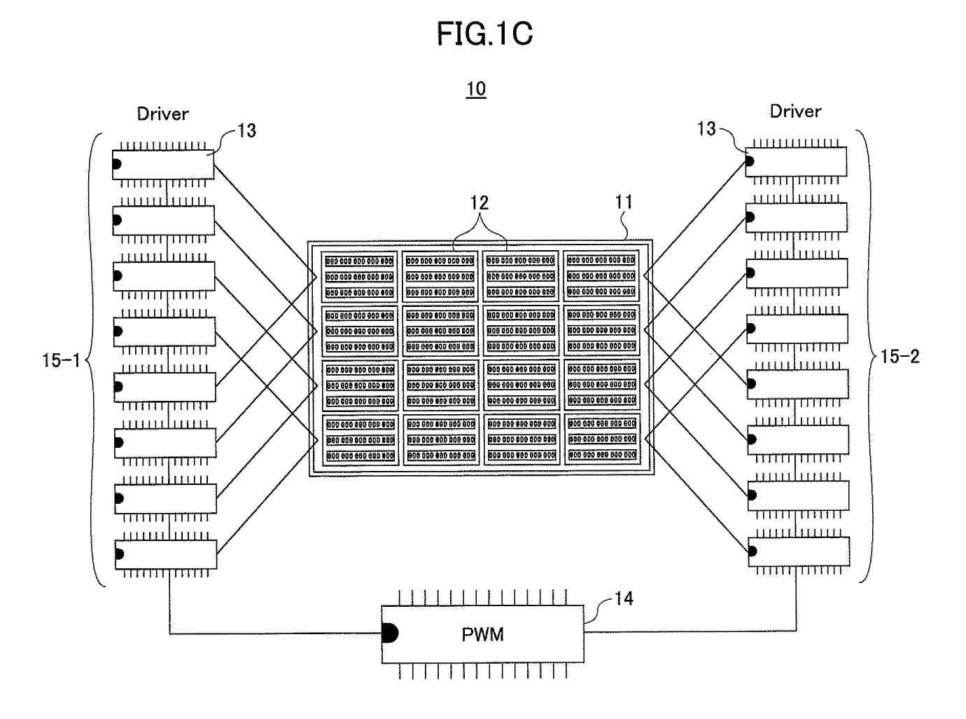

First, a schematic configuration of the backlight apparatus in the present embodiment is described with reference to diagrams. FIGS. 1A-1C are diagrams showing examples of schematic configurations of backlight apparatuses. Each of the backlight apparatuses 10 shown in FIGS. 1A-1C is an LED backlight driving control apparatus as an example. FIG. 1A shows a configuration example of a conventional low-voltage driver of an edge RGB type in which a backlight unit is provided in an edge part of a display unit 11 such as a liquid crystal panel. FIG. 1B shows a configuration example of a high-voltage driver of the present embodiment of an edge W (white) type in which a backlight unit is provided in an edge part of the display unit 11. FIG. 1C shows a configuration example of a top RGB type in which the backlight unit is provided in the backside of the display unit 11. As to LED backlight in embodiments of the present invention, the type is not limited to the RGB type and the white type, and other types can be used.

As shown in FIGS. 1A-1C, each backlight apparatus 10 is provided with the display unit 11 such as an LCD (Liquid Crystal Display) panel, an element block 12 in which a plurality of light-emitting elements such as LEDs are arranged serially at predetermined intervals, a driver IC (LED driving control unit) 13 that is a driver device, and a control IC (PWM) 14 as a main controller for controlling backlights for the display unit 11.

In the example shown in FIG. 1A, one control IC (PWM) 14 performs driving control on four driver ICs 13-1-13-4. In the example of FIG. 1B, one control IC (PWM) 14 performs driving control on one driver IC 13. In the example shown in FIG. 10, one control IC (PWM) 14 performs driving control on driver IC groups 15-1 and 15-2 in which a plurality of driver ICs 13 are connected serially.

In the above-mentioned configurations, in each of the LED backlight driving control apparatus, the control IC (PWM) 14 generates a control signal by performing pulse width modulation, and outputs a brightness control signal to the driver IC 13 or the driver IC group 15 in order to turn on LEDs in the element block at predetermined timing. Accordingly, the driver IC 13 or the driver IC group 15 can turn on corresponding LEDs at the predetermined timing.

As shown in FIGS. 1A-1C, the driver IC 13 or the driver IC group 15 controls output of a plurality of brightness blocks. Also, the control IC (PWM) 14 shown in FIG. 1A supplies a voltage of 5-24 V at the maximum as a low voltage to the driver ICs 13-1-13-4 of low withstand voltage. The control IC (PWM) 14 shown in FIG. 1B supplies a high voltage determined according to the number of serially-connected LEDs to the driver IC 13 of high withstand voltage. The high voltage may be set to be a voltage that is increased in proportion to the number of serially-connected LEDs. For example, assuming that a Vf voltage of one LED is about 3 V, the voltage becomes about 150 V when 50 LEDs are serially connected, and the voltage becomes about 300 V when 100 LEDs are serially connected.

Accordingly, as to the case of FIG. 1A, LED currents i1, i2, i3 and i4 flow through the driver ICs 13-1-13-4 respectively, so that the brightness is determined based on the current value. At this time, current differences become brightness differences, so that unevenness of brightness occurs.

On the other hand, according to the driver IC 13 of high withstand voltage of the present embodiment shown in FIG. 18, since one LED current i flows, the brightness is proportional to the current, and the brightness becomes constant. Therefore, according to the present embodiment, the current supply line is integrated by the high-withstand voltage driver IC, so that the current can be always supplied stably and the unevenness of brightness of LEDs can be prevented. Also, as shown in FIG. 1C, even in the case where LEDs are placed in the whole backside of the screen of the display unit 11, the number of driver ICs can be decreased by using high-withstand voltage driver ICs as the driver IC groups 15-1 and 15-2, so that wiring structure and the like can be simplified.

<Brightness Control of Backlight>

The backlights applied to the above-mentioned embodiment are provided on a back or a side of the display unit 11 such as an LCD panel, for example. Also, the backlights comprise light-emitting elements such as LEDs corresponding to RGB respectively, for example. The backlights are divided into blocks, each block including a unit of a plurality of light-emitting elements. Brightness control is performed for each block of the light-emitting elements using a driver IC (Integrating Circuit) corresponding to the light-emitting elements, for example.

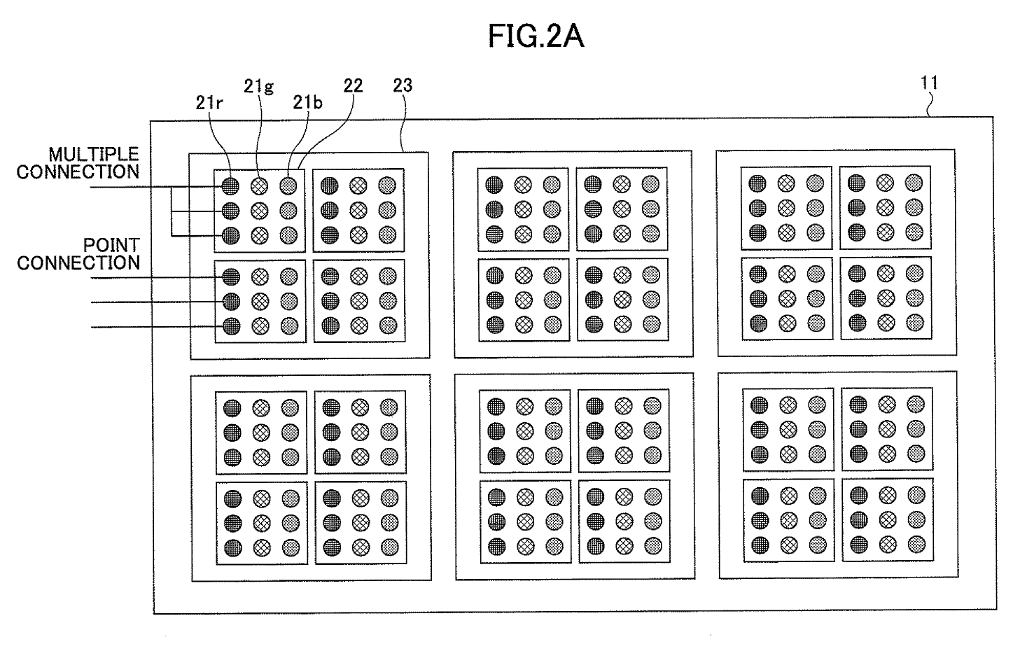

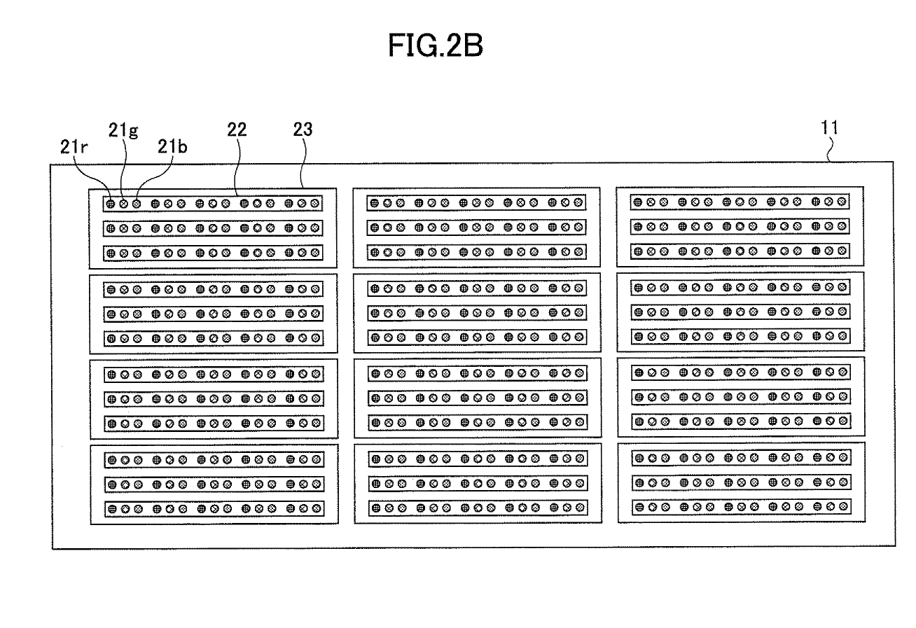

Here, examples of block configurations of the light-emitting elements are described. FIGS. 2A and 2B are diagrams showing examples of block configurations of light-emitting elements that can be applied in the present embodiment. Each of FIGS. 2A and 2B shows LEDs for an LCD backlight. As shown in FIGS. 2A and 2B, a predetermined screen display area of the display unit 11 includes elements 21r, 21g and 21b for R, G and B respectively. The elements 21r, 21g and 21b of the colors form a cell. Also, a plurality of cells forms an element block 22 (corresponding to the above-mentioned element block 12). Also, these elements are connected to driver ICs by multiple connections or point connections.

In addition, a predetermined number of element blocks 22 are placed at predetermined positions, which form a brightness control block 23 for performing control of brightness correction and the like. In the present embodiment, although examples of the number and the placement of the brightness control blocks 23 are shown in FIGS. 2A and 2B, the present invention is not limited to those. The number and the placement may be appropriately set according to a screen size and the like of the display unit 11.

The backlight shown in FIGS. 2A and 2B is a so-called top-type backlight that is placed on the backside of the LCD panel. But, the present invention is not limited to that type. For example, a configuration of a so-called edge type can be used in which the backlight is placed in the lower side of the screen of the display unit 11, or placed in one side (right side, left side) or both sides of the screen.

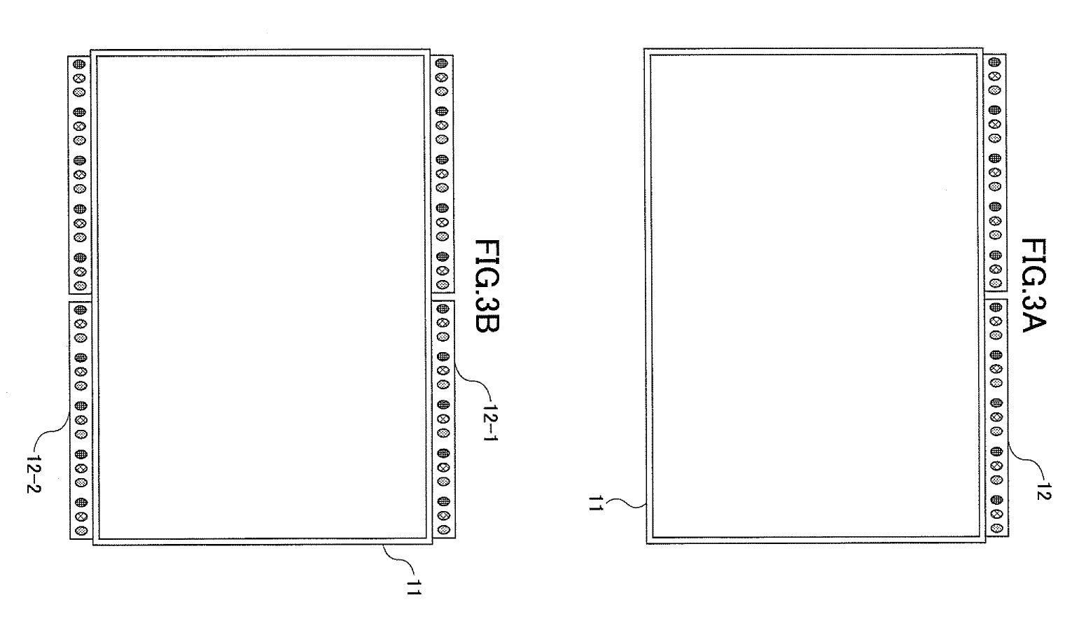

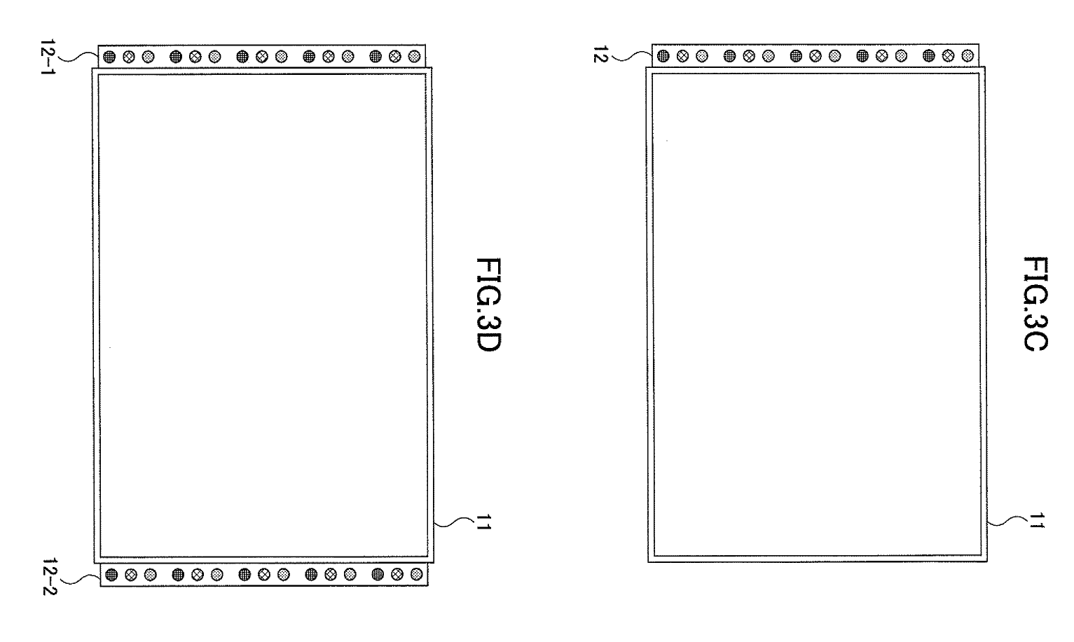

FIGS. 3A-3E are diagrams showing arrangement examples of LED backlights. As shown in FIGS. 3A-3E, the display unit such as an LCD panel is provided with an element block 12 at a predetermined position, wherein a plurality of LEDs are arranged at predetermined positions in the element block 12.

More specifically, in the example shown in FIG. 3A, the element block 12 is placed on the upper side of the display unit 11. In the example shown in FIG. 3B, element blocks 12-1 and 12-2 are placed on upper and lower sides of the display unit 11. In addition, as shown in the example of FIG. 3C, the element block 12 may be placed on one side (left or right, left in the case of FIG. 3C) of the display unit 11. Also, as shown in FIG. 3D, the element blocks 12-1 and 12-2 may be placed in both of the left and the right sides. Further, as shown in FIG. 3E, a predetermined number of element blocks 12 may be arranged on the backside of the display unit 11.

In the present invention, backlight placement is not limited to the above-mentioned examples. For example, the element blocks may be placed in upper and lower sides in addition to the left and right sides, and two or more of the above-mentioned examples may be combined. Also, the element block 12 may be divided into blocks of a size according to at least one of detection results of APL (Average Picture Level) information, brightness histogram information, color histogram information and frequency histogram information obtained from an input image signal, for example. The present invention is not limited to that. The element block 12 may be divided into blocks of a predetermined size.

In the present embodiment, when a fault such as a break occurs due to an end of life and the like in at least one of LEDs that are serially connected in the element block 12, bypass driving control is performed such that the faulted LED does not affect the other LEDs. This feature is described below more specifically.

<Defect LED Bypass Driving Control>

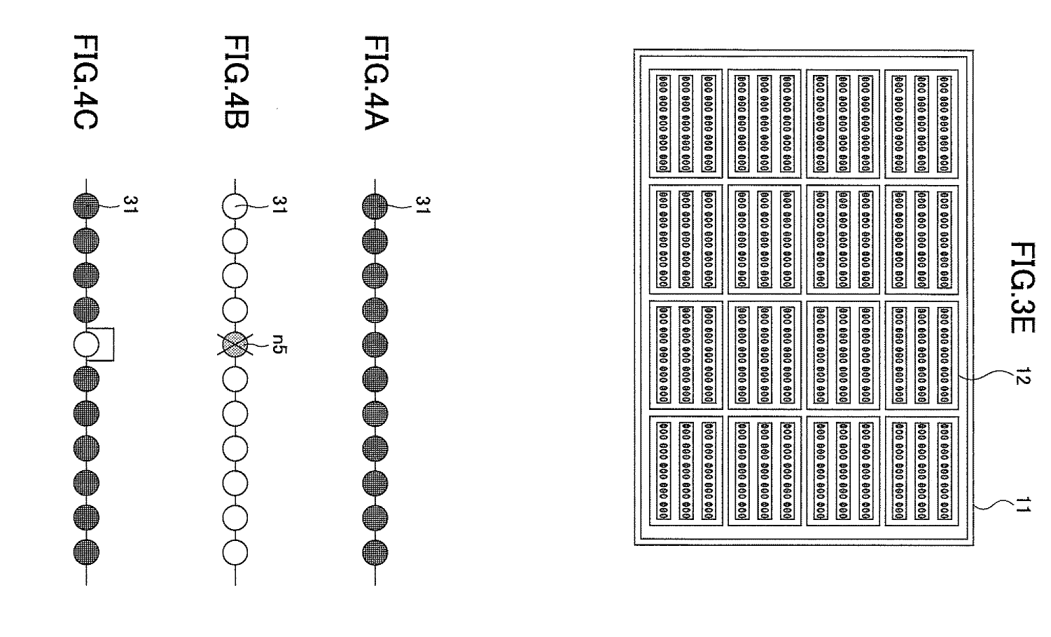

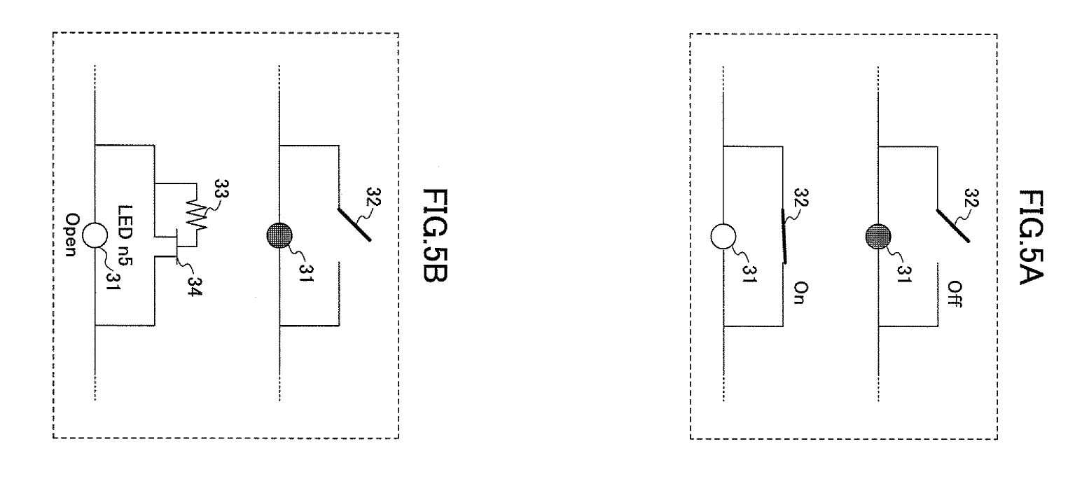

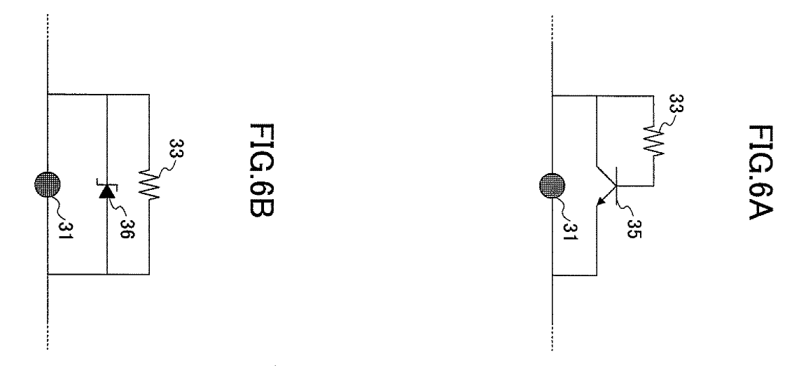

FIGS. 4A-4C are diagrams showing an example of defective LED bypass driving control in the present embodiment. FIGS. 5A and 5B shows examples of bypass circuits according to the present embodiment. FIGS. 5A and 58 shows examples of switching circuits in bypass driving control.

FIG. 4A shows a case where LEDs 31 are turned on normally, FIG. 4B shows a case where open fault occurs in an LED n5, and FIG. 4C shows a manner in which LEDs other than the defect LED n5 are turned on by causing a short in the LED n5. As mentioned above, in the case when a plurality of LEDs 31 are used as illumination or backlight of an LCD panel, the plurality of LEDs 31 are arranged serially and turned on (FIG. 4A). In this case, in a conventional technique, if an open fault occurs in at least one of the serially-connected LEDs, the current does not flow through all of the LEDs 31, so that every LED is turned off (FIG. 4B).

Thus, in the present embodiment, as shown in FIG. 5A, for example, an LED bypass driving circuit is provided. According to the circuit, when the open fault occurs in an LED 31, a switch circuit (SW) 32 that is a bypass circuit connected in parallel is automatically turned to an ON state from an OFF state that is a normal state, so that turn-on state of other LEDs 31 continues (FIG. 4C).

According to an embodiment, the bypass circuit may be configured as an FET-SW circuit that includes a resistance 33 and an FET type switching (FET-SW) element 34 as shown in FIG. 5B, for example. In this case, when an open fault occurs in an LED n5 in the serially-connected LEDs 31 shown in FIG. 4B, for example, a current flows through the resistance 33 shown in FIG. 5B, so that the FET-SW element 32 is turned on, and a short between both ends of the LED n5 occurs. Accordingly, a current flows through the other LEDs so that the other LEDs can continue to be in the ON-state.

The bypass circuit shown in FIGS. 5A and 5B is provided for each of the LEDs 31 that are connected serially forming the element block 12. Also, as the bypass circuit, although configurations shown in FIGS. 5A and 5B can be used, the present invention is not limited to these. For example, a transistor type switching (Tr-SW) circuit, a zener diode circuit and the like may be used.

In the following, bypass circuit configurations using the Tr-SW circuit and the zener diode circuit are described with reference to figures. FIGS. 6A and 6B are diagrams showing other examples of the bypass circuit of the present embodiment. FIG. 6A shows an example of the Tr-SW circuit, and FIG. 6B shows an example of the zener diode circuit. FIGS. 6A and 6B show examples for an LED 31 in the serially-connected LEDs 31.

The Tr-SW circuit shown in FIG. 6A includes a resistance 33 and a Tr-SW element 35. When the LED 31 is operating normally, the Tr-SW element is in a OFF state. When an open fault occurs in the LED 31, a current flows through the resistance 33 shown in FIG. 6A, and the Tr-SW element 35 is turned to an ON state, so that the both ends of the LED 31 becomes a short state. Accordingly, since the current flows through other LEDs, the ON-state of other LEDs can be kept.

The zener diode circuit shown in FIG. 6B includes a resistance 33 and a zener diode element 36. In the present embodiment, a breakdown voltage of the zener diode element 36 is equal to or greater than Vf voltage of the LED 31.

When the LED 31 is operating normally, the zener diode element 36 is in an OFF state. When an open fault occurs in the LED 31, a current flows through the resistance 33 shown in FIG. 6B, and the zener diode element 36 is turned to an ON state, so that the both ends of the LED 31 becomes a short state. Accordingly, since the current flows through other LEDs, the ON-state of the other LEDs can be kept.

That is, according to the above-mentioned embodiment, by providing the bypass circuit for each LED, even when an open fault occurs in one or more LEDs, decrease of brightness can be suppressed so that it becomes possible to continue to use the backlight with a proper brightness level. Accordingly, it becomes possible to largely improve MTBF (Mean Time Between Failures) and to largely reduce failure prevention cost.

Also, in the present embodiment, the resistance and diode and the like are provided such that the voltage drop in the automatic switching operation state is set to be the same as a value when LEDs are turned on normally. Thus, driving control can be performed more stably.

In the present embodiment, at least one of the bypass circuits shown in FIGS. 5A and 5B, and FIGS. 6A and 6B is used for each LED of the serially-connected LEDs. But, the present invention is not limited to these. For example, the configurations may be combined. Therefore, a bypass circuit can be selected from among several types of bypass circuits according to differences of color of LED, placement position, frequency of lighting, and the like.

Also, in the present embodiment, current control can be performed by the LED driver IS when performing automatic switching operation. More specifically, the driver IC controls an LED current to be constant when the switch is turned on/off. Accordingly, stable backlight driving control can be performed.

<Display Apparatus Including Backlight Apparatus>

Next, a configuration example of a display apparatus including the backlight apparatus is described with reference to a drawing.

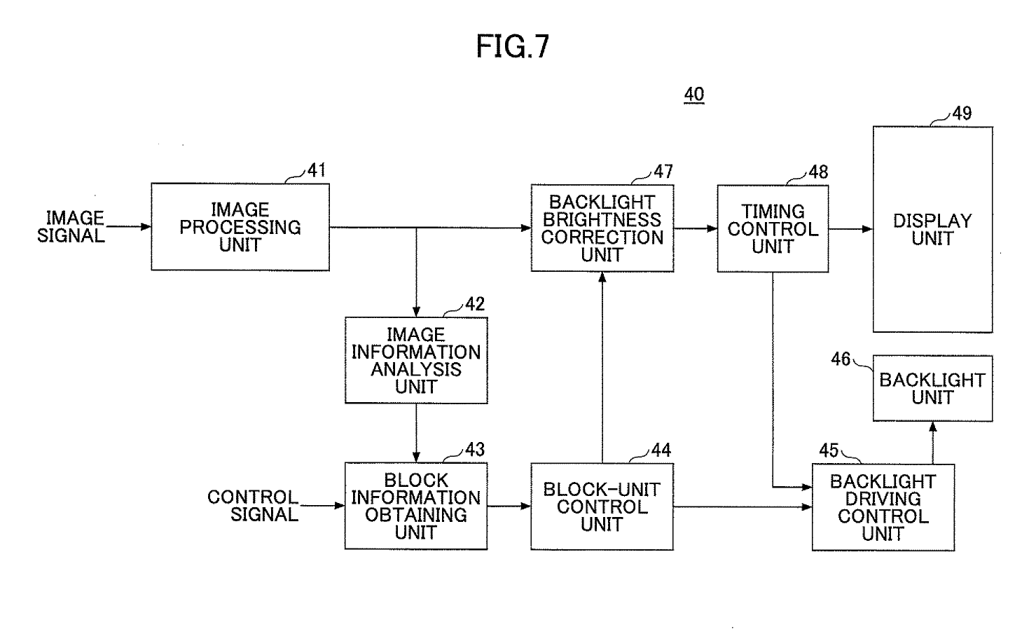

FIG. 7 is a diagram showing an example of a functional configuration of a brightness control apparatus including the backlight apparatus of the present embodiment. The display apparatus 40 shown in FIG. 7 includes an image processing unit 41, an image information analysis unit 42, a block information obtaining unit 43, a block-unit control unit 44, a backlight driving control unit 45, a backlight unit 46, a backlight brightness correction unit 47, a timing control unit 48 and a display unit 49. In the present embodiment, the backlight apparatus corresponds to the backlight driving control unit 45 and the backlight unit 46, for example.

The image processing unit 41 decodes an input image signal in a case when the image signal is compression-coded. Also, in a case when the image signal is encrypted by scrambling and the like in a conditional access system, the image processing unit 41 decodes (descrambles) the input image signal using preset key information. That is, the image processing unit 41 properly converts the input image signal such that each unit of the latter stages can process the image signal and that an image can be displayed on the display unit 49. Also, the image processing unit 41 outputs the image signal to the image information analysis unit 42 and to the backlight brightness correction unit 47.

The image information analysis unit 42 detects, from the image signal supplied from the image processing unit 41, at least one piece of APL information, brightness histogram information, color histogram information (hue, saturation) and frequency histogram information, and the image information analysis unit 42 performs analysis on image information. That is, since the image information analysis unit 42 can obtain the histogram information and profile information and the like for the image (picture) and the like, brightness control for backlights corresponding to an image can be optimally performed based on the information. The image information analysis unit 42 outputs an analysis result to the block information obtaining unit 43.

The block information obtaining unit 43 sets a size (the number of pixels, inches and the like) of a block unit based on the analysis result obtained by the image information analysis unit 42 and a preset control signal for the image signal. Accordingly, by setting the size of the block unit based on the image information and the like, the backlight can be controlled for each block, that is, in units of blocks, in association with image information.

As to timing for executing processing by the block information obtaining unit 43, the block information obtaining unit 43 may perform the processing when an external control signal is input. Also, the block information obtaining unit 43 may perform the processing when the analysis result is input from the image information analysis unit 42 based on preset control information, for example. The block information obtaining unit 14 outputs the obtained block information to the block-unit control unit 44.

The block-unit control unit 44 performs offset control and non-linear correction for each block based on the block information obtained by the block information obtaining unit 43 in order to control brightness of backlights for each block corresponding to the image signal. Also, the block-unit control unit 44 generates a control signal by performing pulse modulation processing by PWM (Pulse Width Modulation) in association with brightness control information of each block for the input image signal. The control IC 14 is included in the block-unit control unit 44.

In addition, the block-unit control unit 44 outputs a brightness control signal for controlling brightness of LEDs at predetermined timing to the backlight driving control unit 45 (corresponding to driver IC 13). Also, the block-unit control unit 44 outputs the brightness control information to the backlight brightness correction unit 47. Further, the block-unit control unit 44 outputs the offset control information and the non-linear correction information of each block to the backlight driving control unit 45 and the backlight brightness correction unit 47.

The backlight driving control unit 45 performs driving control for backlights corresponding to each block position by using the brightness control information, the offset control information and the non-linear correction information for each corresponding block obtained by the block-unit control unit 44, so that the backlight driving control unit 45 turns on LEDs of the backlight unit 46 at proper timing. The driver IC 13 and the driver IC group 15 are included in the backlight driving control unit 45.

The backlight driving control unit 45 of the present embodiment outputs a control signal, to the backlight unit 46, for driving LEDs by timing control based on a clock signal from the timing control unit 48 in order to drive backlights in synchronization with the image signal output from the display unit 49 by the timing control unit 48.

Regarding the backlight unit 46, a backlight (element) includes LED (Light Emitting Diode) elements of three colors (R (red), G (green) and B (blue)) respectively, the three colors being normally provided in an LCD. Therefore, it is desirable to perform adjustment for each LED element in order to adjust each pixel. However, in this case, remarkable cost and processing time are required. Thus, in the present embodiment, processing is performed for each predetermined block. Accordingly, cost reduction and efficiency can be realized.

The backlight driving control unit 45 outputs a respective driving control signal corresponding to each block to the backlight unit 46. The backlight unit 46 turns on LEDs placed at predetermined positions of each block with proper brightness levels by performing brightness control set for each block based on the driving control signal corresponding to each block, and irradiates the screen of the display unit 49 with light of the LEDs.

The backlight brightness correction unit 47 performs brightness correction for the image signal obtained by the image processing unit 41 using drive control information for the backlights based on the brightness control information, the offset control information and the non-linear correction information obtained by the block-unit control unit 44. That is, the backlight brightness correction unit 47 performs trimming by performing reverse-correction on dimming control information of each block, and the trimmed information is fed back to the image signal side.

The backlights are placed at the backside of the display unit 49, for example, and operate for each block for brightness control. Also, operation of the backlights is brightness operation of low resolution less than the resolution of the image signal. But, according to the present embodiment, block brightness interference due to difference of brightness resolution from the image signal can be avoided, so that an optimal image that a user can easily watch can be displayed on the display screen.

Also, the backlight brightness correction unit 47 performs correction of the image signal using the offset control information and the non-linear correction information, so that it becomes possible to perform control for brightness, contrast and color and the like as well as impulse control for backlights.

In the present embodiment, it is necessary that the backlight brightness correction unit 47 can properly adjust a correction amount even when information fed back to the image signal side changes according to the configuration of the brightness control block, and even when brightness transmittance and the like of the display unit 49 changes. In such a case, for example, the backlight brightness correction unit 47 can automatically adjust information to be fed back by using a result detected by a camera and the like for detecting brightness transmittance that is preset. The backlight brightness correction unit 47 outputs the image signal corrected by the above-mentioned processing to the timing control unit 48.

The timing control unit 48 performs control of time for displaying the image signal obtained by the backlight brightness correction unit 47 in conformity with the horizontal and vertical directions of the screen of the display unit 49, and generates image information displayed on the screen of the display unit 49 and outputs the generated image to the display unit 49.

In addition, in synchronization with the timing for outputting the image signal to the display unit 49, the timing control unit 48 outputs a timing control signal for turning on backlights corresponding to the image signal to the backlight driving control unit 45 in order to turn on the backlights of the backlight unit 46 in synchronization with the image displayed on the screen.

Accordingly, image output by the display unit 49 can be synchronized with backlight output of the backlight unit 46 corresponding to the image.

The display unit 49 displays image information generated by the timing control unit 48 on the screen. As the display unit 49, an LCD panel can be used, for example. But, the present invention is not limited to using the LCD panel as the display unit 49.

According to the above-mentioned configuration, in the present embodiment, backlights of the display unit 49 such as the LCD panel can be dynamically operated in conjunction with image contents. Thus, images of higher contrast can be provided. That is, according to the present embodiment, optimal backlight control can be performed according to image contents. Therefore, brightness interference to image signals that occurs when performing various dimming operation in the LCD backlight can be improved, so that the dimming operation can be improved into more optimal operation. In addition, by applying the above-mentioned backlight apparatus, proper backlight can be provided according to drive control for unevenness of brightness and a break.

Also, in the present embodiment, optical brightness control based on brightness histogram detection and the like can be realized in addition to reference brightness control processed by the conventional APL detection. For example, by performing color histogram detection, LED backlight control for RGB can be performed according to optimal white balance control and the like.

That is, in the present embodiment, the backlight brightness control may be performed by using only detection results of various histograms, and also the backlight brightness control may be performed by combining the APL detection result and the histogram detection results.

<Other Application Examples of the Backlight Apparatus>

The backlight apparatus of the above-mentioned embodiment can be applied to a lighting apparatus, a digital signage, and other various displays and the like as well as the above-mentioned display apparatus such as a TV. That is, the backlight apparatus of the present embodiment can be applied to overall apparatuses including light-emitting elements such as LEDs that are serially connected. In the following, other application examples of the backlight apparatus are described with reference to drawings.

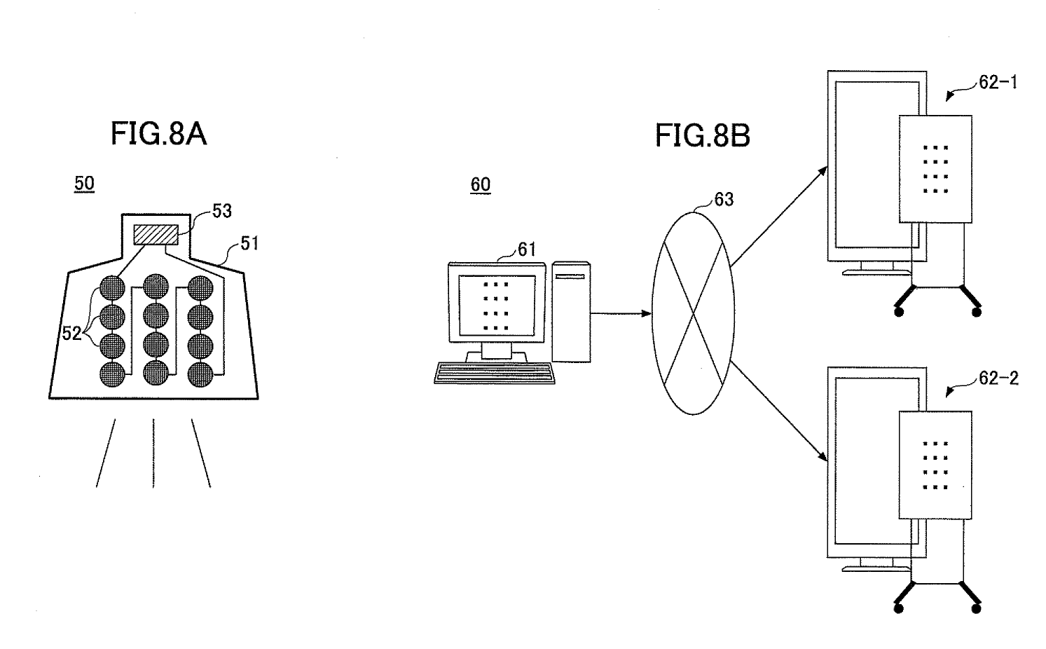

FIGS. 8A and 8B are diagrams for explaining other application examples of the backlight apparatus of the present embodiment. FIG. 8A shows an example in which the backlight apparatus of the present embodiment is applied to a lighting apparatus, and FIG. 8B shows an example in which the backlight apparatus of the present embodiment is applied to a digital signage system.

The lighting apparatus 50 shown in FIG. 8A is an LED lamp as an example. More specifically, the lighting apparatus 50 is configured such that a plurality of LEDs 52 are serially connected in a lamp body 51, and each LED is placed at a predetermined position suitable for a proper lighting direction. Each LED 52 may be configured to be the above-mentioned light-emitting element block.

The serially connected LEDs 52 are connected to a driver IC (LED driving control unit) 53 as shown in FIG. 8A. Driving of each LED is controlled by the driver IC 53. By adopting such a configuration, lighting can be realized by light emitted from the plurality of LEDs.

In addition, in the present embodiment, the above-mentioned bypass circuit is provided for each LED 52 shown in FIG. 8A. Therefore, according to the lighting apparatus 50, even when a break occurs in an LED, a current from the driver IC 53 can be supplied to the other LEDs.

The digital signage system 60 shown in FIG. 8B is configured, for example, to include a PC (personal computer) 61 and a plurality of digital signage apparatuses 61 (digital signage apparatuses 62-1 and 62-2 in the example of FIG. 8B). The PC 61 and the digital signage apparatuses are connected via a communication network 63 represented by the Internet such that transmit and receive of data are available.

In the digital signage system 60 shown in FIG. 8B, contents such as product description and a company name that are created and edited using the PC 60 by a manager are displayed and updated simultaneously on the digital signage apparatuses 62 placed in different places via the communication network 63. Each digital signage apparatus 62 uses a large-sized liquid crystal display, for example, and the backlight apparatus can be applied to such a large-sized liquid crystal display.

For example, in the digital signage apparatus 62 shown in FIG. 8B, when the serially-connected LEDs (light-emitting element block) and a driver IC are used, the above-mentioned bypass circuit is provided for each LED. Thus, according to the digital signage apparatus 62, a current from the driver IC can be supplied to the other LEDs even when a break occurs in an LED. Therefore, also in the other application examples shown in FIGS. 8A and 8B, unevenness of brightness can be prevented, and, illumination and backlight that are robust against a break and that can operate for a long time can be provided. Further, the backlight apparatus can be also applied to a liquid crystal display of the PC 61.

As mentioned above, according to an embodiment of the present invention, the number of driver ICs can be reduced by using a driver IC of high withstand voltage so that the driver IC can drive the serially-connected LEDs collectively. Accordingly, a collective-type LED control system of high withstand voltage can be realized for stably supplying a constant current to each LED. Also, various apparatuses including an LED bypass driving circuit can be provided. In each apparatus including the LED bypass driving circuit, when an open fault occurs in an LED, a switch circuit that is connected in parallel is automatically turned on, so that lighting of the other LEDs can be maintained.

That is, according to the present embodiment, a backlight apparatus for providing proper backlight according to drive control against unevenness of backlight brightness and a break can be provided. Also, a display apparatus including the backlight apparatus and a lighting apparatus including the backlight apparatus can be provided.

The present invention is not limited to the specifically disclosed embodiments, and variations and modifications may be made without departing from the scope of the present invention.

What is claimed is:

1. A backlight apparatus for illuminating a display unit, comprising:
a light-emitting element block including a plurality of light-emitting elements that are connected serially; and
a driving control unit configured to control driving for each of the plurality of light-emitting elements by supplying a current to the light-emitting element block,
wherein each of the plurality of light-emitting elements is provided with a bypass circuit such that, even when a break occurs in a light-emitting element, a current from the driving control unit is supplied to other light-emitting elements.

2. The backlight apparatus as claimed in claim 1, wherein at least one of an FET type switching circuit, a transistor type switching circuit and a zener diode circuit is used as the bypass circuit.

3. The backlight apparatus as claimed in claim 1, wherein the driving control circuit supplies the current to all of the light-emitting elements included in the light-emitting element block by a voltage that is determined according to the number of the serially-connected light-emitting elements.

4. The backlight apparatus as claimed in claim 1, wherein the light-emitting element is an LED.

5. A display apparatus comprising:
a backlight apparatus;
a display unit to be illuminated by the backlight apparatus; and
a correction unit configured to correct brightness of the backlight apparatus according to an image displayed on the display unit,
the backlight apparatus comprising:
a light-emitting element block including a plurality of light-emitting elements that are connected serially; and
a driving control unit configured to control driving for each of the plurality of light-emitting elements by supplying a current to the light-emitting element block,
wherein each of the plurality of light-emitting elements is provided with a bypass circuit such that, even when a break occurs in a light-emitting element, a current from the driving control unit is supplied to other light-emitting elements.

6. The display apparatus as claimed in claim 5, comprising:
a block information obtaining unit configured to divide each frame, included in an image signal input for displaying an image on the display unit, into blocks and to obtain image information for each of the blocks; and
a block-unit control unit configured to perform control for correcting brightness of backlights for each of the blocks divided by the block information obtaining unit,
wherein the backlight apparatus performs drive control of the backlights for each of the blocks based on brightness control information obtained by the block-unit control unit.

7. The display apparatus as claimed in claim 6, comprising:
a backlight brightness correction unit configured to perform correction on the input image signal based on the brightness control information for the backlights,
wherein the display apparatus displays an image signal obtained by the backlight brightness correction unit on the display unit.

8. A lighting apparatus, comprising:
a light-emitting element block including a plurality of light-emitting elements that are connected serially; and
a driving control unit configured to control driving for each of the plurality of light-emitting elements by supplying a current to the light-emitting element block;
wherein each of the plurality of light-emitting elements is provided with a bypass circuit such that, even when a break occurs in a light-emitting element, a current from the driving control unit is supplied to the other light-emitting elements.
